(19) United States
(12) Patent Application Publication
(10) Pub. No.: US 2024/0121862 A1
(43) Pub. Date: Apr. 11, 2024

(54) LIQUID HEATING DEVICE

(71) Applicant: Niterra Co., Ltd, Nagoya-shi,Aichi (JP)

(72) Inventors: Yusuke MAKINO, Nagoya-shi, Aichi (JP); Yuya HIGASHIDE, Nagoya-shi, Aichi (JP)

(73) Assignee: Niterra Co., Ltd, Nagoya-shi, Aichi (JP)

(21) Appl. No.: 18/280,411

(22) PCT Filed: Oct. 31, 2022
(86) PCT No.: PCT/JP2022/040633

§ 371 Date: Sep. 5, 2023

(30) Foreign Application Priority Data
Jan. 7, 2022 (JP) 2022-001548

(51) Int. Cl. H05B 3/46

(52) U.S. Cl. CPC H05B 3/46; H05B 2203/021

(57) ABSTRACT

A liquid heating device (200) including: a container surrounding an internal space (101i) and having an opening (107m1-107m3); a ceramic heater (171-173) extending in a front-rear direction L and penetrating through the opening, such that a distal-end portion (17T) of the ceramic heater is located in the internal space and a base-end portion (17R) thereof is located outside the internal space, the ceramic heater having a heat generation portion (17a) at the distal-end portion; and a fixation member (180) sealing a gap between the opening and the ceramic heater, and fixing the ceramic heater to the container, wherein a liquid W in the internal space is heated by the ceramic heater, and the liquid passes through a flow path (103i) penetrating from outside through inside of the fixation member, so as to be introduced into the internal space.

### TECHNICAL FIELD

The present invention relates to a liquid heating device for producing warm water or the like by a ceramic heater.

### BACKGROUND ART

Warm water is needed for a warm water washing toilet seat, a fuel cell system, a water heater, a 24-hour bath system, heating of a washer fluid for a vehicle, an in-vehicle air conditioner, and the like. Accordingly, a liquid heating device which heats water by a built-in heater is used (Patent Document 1). In particular, for the purpose of rapid heating for warm water of a warm water washing toilet seat, etc., or achieving downsizing of the liquid heating device, a rod-shaped ceramic heater having a heat generation portion embedded in a ceramic sheet wrapped around the outer circumference of an elongated ceramic base is used.

The distal-end side of the ceramic heater penetrates through an opening of a side wall of a container of the liquid heating device so as to be placed in the container, and the base-end side thereof is exposed to outside. In addition, the ceramic heater has an inner hole penetrating in the longitudinal direction, so that water to be heated is introduced into the container through the inner hole from the base-end side exposed to outside and is heated by the inner surface and the outer surface of the ceramic heater, and then the heated water is discharged.

### PRIOR ART DOCUMENT

### Patent Document

Patent Document 1: Japanese Patent Application Laid-Open (kokai) No. 2016-51546(FIG. 4)

### SUMMARY OF THE INVENTION

### Problem to be Solved by the Invention

Such liquid heating devices are required to be downsized, and ceramic heaters also tend to be downsized. However, if a ceramic heater is downsized (the diameter thereof is reduced), the diameter of the inner hole thereof is also reduced, so that it becomes difficult to pass water through the inner hole.

Then, if such a structure that heats water by only the outer surface of the heater without passing water through the inner hole is adopted, the inner hole part of the heater is not cooled by water to be heated, so that the heater is overheated. Thus, a container member or a seal at a gap part between the heater and the container might be thermally deformed, or water leakage or the like might occur.

Accordingly, an object of the present invention is to provide a liquid heating device configured to suppress liquid leakage and thermal deformation at a part between a ceramic heater and a container.

### Means for Solving the Problem

In order to solve the above problem, a liquid heating device of a first aspect of the present invention is a liquid heating device comprising: a container surrounding an internal space and having an opening; a ceramic heater extending in a front-rear direction and penetrating through the opening, such that a distal-end portion of the ceramic heater is located in the internal space and a base-end portion thereof is located outside the internal space, the ceramic heater having a heat generation portion at the distal-end portion; and a fixation member sealing a gap between the opening and the ceramic heater, and fixing the ceramic heater to the container, wherein a liquid in the internal space is heated by the ceramic heater, and the liquid passes through a flow path penetrating from outside through inside of the fixation member, so as to be introduced into the internal space.

With this liquid heating device, since the flow path penetrates from outside through inside of the fixation member, the liquid before heated passes through the flow path, whereby the fixation member is cooled. Therefore, when such a structure that heats the liquid by only the outer surface of the ceramic heater without passing the liquid through the inner hole is adopted, even if the heating temperature of the heater becomes high, overheating of the fixation member around the ceramic heater is suppressed, and therefore thermal deformation of the container contacting with the fixation member can be suppressed and liquid leakage between the ceramic heater and the container can be suppressed.

A liquid heating device of a second aspect of the present invention is a liquid heating device comprising: a container having a wall surrounding an internal space; and a ceramic heater extending in a front-rear direction and penetrating the wall, such that a distal-end portion of the ceramic heater is located in the internal space and a base-end portion thereof is located outside the internal space, the ceramic heater having a heat generation portion at the distal-end portion, wherein a liquid in the internal space is heated by the ceramic heater, the ceramic heater is fixed to the wall, and the liquid passes through a flow path penetrating from outside through inside of the wall at a position different from the ceramic heater, so as to be introduced into the internal space.

With this liquid heating device, since the flow path penetrates from outside through inside of the wall, the liquid before heated passes through the flow path, whereby the wall is cooled. Therefore, when such a structure that heats the liquid by only the outer surface of the ceramic heater without passing the liquid through the inner hole is adopted, even if the heating temperature of the heater becomes high, thermal deformation of the wall around the ceramic heater can be suppressed and liquid leakage between the ceramic heater and the container can be suppressed.

In the liquid heating device of the present invention, the wall and the ceramic heater may be in close contact with each other without a gap therebetween.

With this liquid heating device, production thereof is facilitated and liquid leakage from between the container and the ceramic heater can be more assuredly suppressed.

In the liquid heating device of the present invention, an outer diameter of the ceramic heater may be not greater than 5 mm.

When the outer diameter of the ceramic heater is not greater than 5 mm, even if the ceramic heater has an inner hole, the diameter of the inner hole is small so that it is difficult to introduce the liquid and the ceramic heater is likely to be overheated. Therefore, the present invention works more effectively.

The liquid heating device of the present invention may comprise a plurality of the ceramic heaters extending in the front-rear direction apart from each other, wherein the flow path is formed between at least two of the ceramic heaters as seen in the front-rear direction.

With this liquid heating device, it is possible to effectively cool a part where heat is likely to be accumulated between the two ceramic heaters across the flow path.

In the liquid heating device of the present invention, an axial direction of an end part facing the internal space, of the flow path, may be along the front-rear direction.

With this liquid heating device, the liquid readily flows on the outer surfaces of the ceramic heater along the front-rear direction L in which the ceramic heater extend, whereby a state in which the cooling effect is reduced due to the liquid staying near the flow path can be suppressed.

### Advantageous Effects of the Invention

According to the present invention, there can be obtained a liquid heating device configured to suppress liquid leakage and thermal deformation at a part between a ceramic heater and a container.

### BRIEF DESCRIPTION OF THE DRAWINGS

FIG. 1 Perspective view showing the outer appearance of a liquid heating device according to an embodiment of a first mode of the present invention.

FIG. 2 Exploded perspective view of liquid heating device.

FIG. 3 Sectional view along line A-A in FIG. 1.

FIG. 4 Perspective view showing the outer appearance of a ceramic heater.

FIG. 5 Exploded perspective view showing the configuration of the ceramic heater.

FIG. 6 Sectional view of a liquid heating device according to an embodiment of a second mode of the present invention.

FIG. 7 Sectional view of a liquid heating device according to an embodiment a second mode of the present invention in a modification.

### MODES FOR CARRYING OUT THE INVENTION

Hereinafter, an embodiment of the present invention will be described.

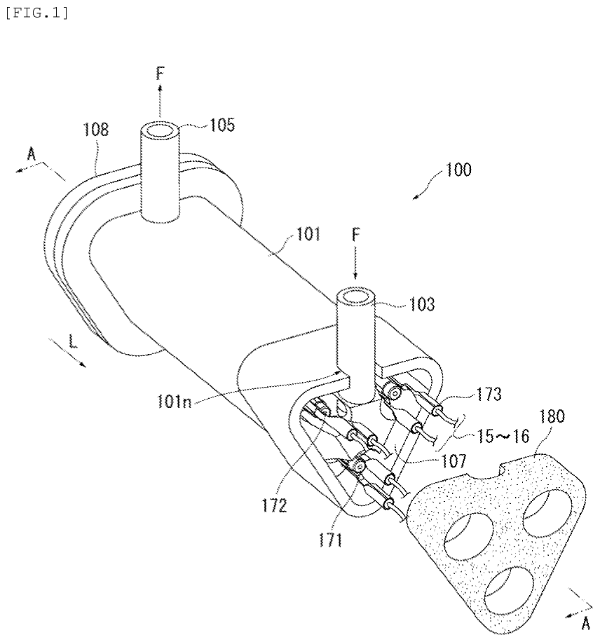

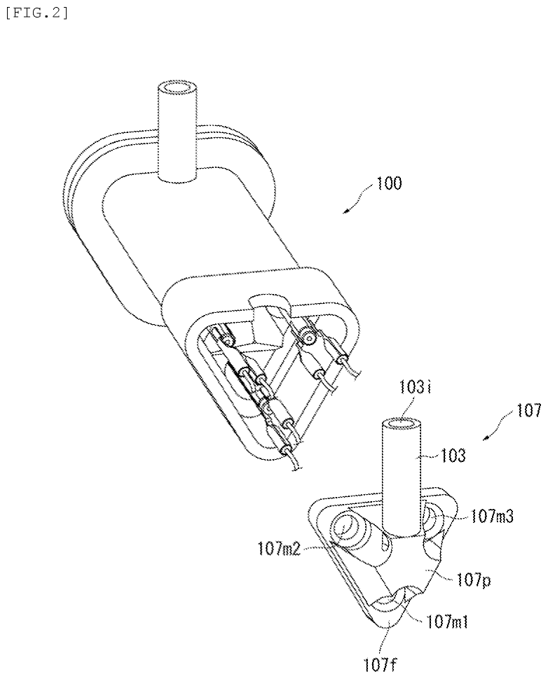

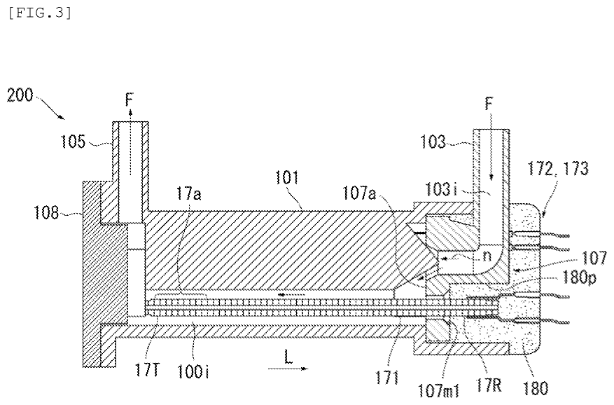

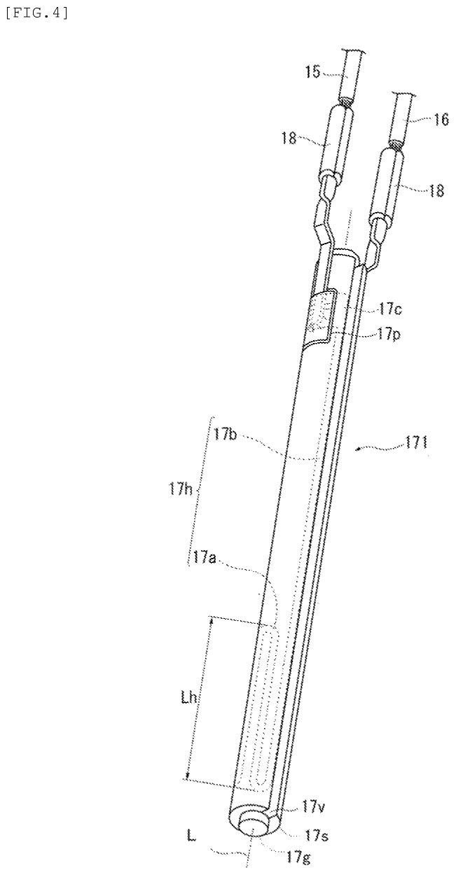

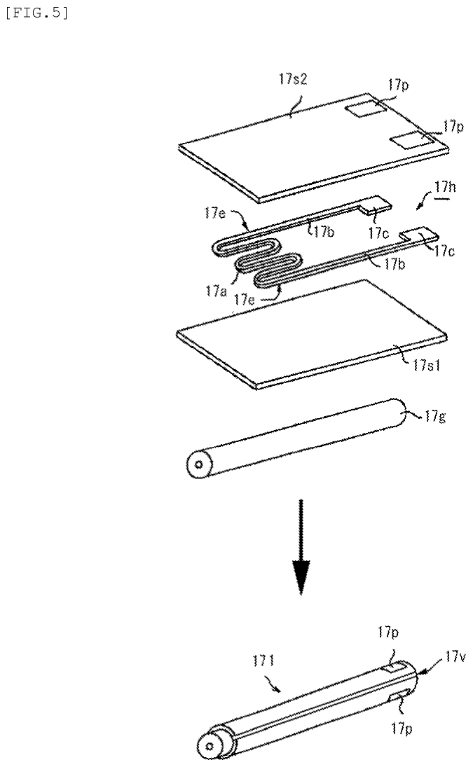

FIG. 1 is a perspective view of a liquid heating device 200 according to the embodiment of the first mode of the present invention. FIG. 2 is a Exploded perspective view of liquid heating device 200. FIG. 3 is a Sectional view along line A-A in FIG. 1. FIG. 4 is a perspective view of a ceramic heater 171. FIG. 5 is an exploded perspective view of the ceramic heater 171.

In this embodiment, the liquid heating device 200 is provided to a warm water washing toilet seat, and heats ordinary-temperature water by two built-in ceramic heaters 171, 172, to supply warm water.

The liquid heating device 200 includes a container 100 having substantially a triangular tubular shape (a tubular shape whose cross-section is a triangle) in its entirety, and the three ceramic heaters 171 to 173.

The container 100 has an oblong tubular trunk portion 101 having an internal space 100i for storing a liquid W (water), a front-end lid 107 and a rear-end lid 108 that close openings at both ends in the axial direction of the trunk portion 101, and an inlet 103 and the outlet 105 for the liquid W which are provided integrally with the trunk portion 101. The container 100 is made of resin, for example.

The inlet 103 and the outlet 105 are provided integrally with the front-end lid 107 and the trunk portion 101, respectively. The outer periphery at a front end in the axial direction of the trunk portion 101 (an end on a side where the ceramic heaters 171 to 173 are exposed in FIG. 1) has a protrusion 101p protruding outward in the axial direction along the contour, and the front-end lid 107 can be stored on the inner side of the protrusion 101p.

A rear end in the axial direction of the trunk portion 101 protrudes in a flange shape in the radial direction, and the rear-end lid 108 is sealed at the flange in a liquid-tight state via a rubber seal such as a packing, for example.

As described above, the internal space 100i is surrounded by the trunk portion 101, the front-end lid 107, and the rear-end lid 108 forming the container 100.

The three ceramic heaters 171 to 173 have rod shapes extending in a front-rear direction L, and extend in the same direction (in parallel). Base-end portions 17R of the ceramic heaters 171 to 173 penetrate through three openings 107m1 to 107m3 of the front-end lid 107. Gaps between the ceramic heaters 171 to 173 and the openings 107m1 to 107m3 are sealed by a fixation member 180 (see FIG. 2) made of epoxy resin, whereby the ceramic heaters 171 to 173 are fixed to the container 100 in a cantilever manner.

Thus, a distal-end portion 17T of each ceramic heater 171 to 173 is located in the internal space 100i. Needless to say, the position of the fixation member 180 is on the base-end side relative to heat generation portions 17a of the ceramic heaters described later.

Lead wires 15, 16 described later for supplying power from outside are connected to the base-end portion 17R sides of the ceramic heaters 171 to 173.

In this example, the axial direction of the trunk portion 101 is parallel to the front-rear direction L, and the ceramic heaters 171 to 173 are stored in the internal space 100i of the trunk portion 101 such that the direction in which the ceramic heaters 171 to 173 are arranged side by side is along the axial direction of the trunk portion 101.

Although not shown, in this example, the liquid heating device 200 is provided to the warm water washing toilet seat such that the front-rear direction L is substantially the horizontal direction and the outlet 105 side is located slightly upward, and the ceramic heaters 171 to 173 are laid horizontally.

The inlet 103 and the outlet 105 communicate with the internal space 100i and are located apart from each other in the front-rear direction L (also corresponding to the axial direction of the trunk portion 101). The liquid W introduced through the inlet 103 from outside passes through the internal space 100i along a flow direction F and then is discharged from the outlet 105.

A gap is formed between the inner wall of the container 100 and each ceramic heater 171 to 173. The liquid W introduced into the internal space 100i through the inlet 103 contacts with the outer surfaces of the ceramic heaters 171 to 173 along the front-rear direction L, thus being heated, and then the liquid W flows to the outlet 105.

As shown in FIG. 2, the front-end lid 107 includes a flange portion 107f which is substantially triangular and has a plate shape, the three openings 107m1 to 107m3 provided in the flange portion 107f, a raised portion 107p, and the inlet 103 extending outward from the raised portion 107p.

The three openings 107m1 to 107m3 are located near the respective vertices of the flange portion 107f and form circular holes. The raised portion 107p is raised outward from the flange portion 107f, at a position on the inner side of the openings 107m1 to 107m3. The inlet 103 connects to the raised portion 107p and extends from the raised portion 107p along the plate surface of the flange portion 107f to the outer side relative to the outer periphery of the flange portion 107f. More specifically, the inlet 103 extends so as to cross one side of the flange portion 107f between the two adjacent openings 107m3 and 107m2.

As shown in FIG. 3, an inner hole 103i (flow path for liquid W) of the inlet 103 is bent to be substantially perpendicular to the plate surface of the flange portion 107f, inside the raised portion 107p, and opens at an inner surface 107a of the flange portion 107f.

A cutout 101n (FIG. 2) for the inlet 103 to pass is provided at a part of the protrusion 101p of the container 100.

The fixation member 180 made of epoxy resin is provided so as to not only fill the gaps between the ceramic heaters 171 to 173 and the openings 107m1 to 107m3 but also bury the front-end lid 107.

Next, with reference to FIG. 4 and FIG. 5, the configuration of the ceramic heater will be described. The ceramic heaters 171 to 173 have the same shape and therefore the ceramic heater 171 will be described.

As shown in FIG. 4, the ceramic heater 171 has a heat generation body 17h which generates heat by being energized from outside via the lead wires 15, 16. The heat generation body 17h has, on the front-end side, the heat generation portion 17a formed by meandering a conductor in the front-rear direction L as a heat generation pattern, and has a pair of lead portions 17b led from both ends of the heat generation portion 17a to the rear-end side.

The heat generation portion 17a has a length of Lh in the front-rear direction L.

More specifically, as shown in FIG. 5, the heat generation body 17h has the heat generation portion 17a, both lead portions 17b, and electrode patterns 17c formed at rear ends of both lead portions 17b, and the heat generation body 17h is held between two ceramic green sheets 17s1, 17s2. As the ceramic green sheets, alumina is used. As the heat generation portion 17a and the lead portions 17b, tungsten, rhenium, or the like is used. Two electrode pads 17p to which lead terminals 18 (see FIG. 4) are to be brazed are formed on the front surface of the ceramic green sheet 17s2, and the electrode patterns 17c are connected to the electrode pads 17p via through holes, thus forming a laminated body of the ceramic green sheets.

Further, this laminated body is wrapped around a rod-shaped ceramic base 17g mainly composed of alumina, etc., with the ceramic green sheet 17s2 set on the front side, and then these are sintered, whereby the ceramic green sheets 17s1, 17s2 form a ceramic sheet 17s wrapped around the outer circumference of the ceramic base 17g so as to be integrated and thus the ceramic heater 171 can be produced.

The lead wires 15, 16 are crimped with the lead terminals 18 so as to be electrically connected thereto (see FIG. 4).

In this example, the ceramic base 17g is solid, but may have a tubular shape. In a case of a tubular shape, it is desirable to make sealing with resin or the like so as not to leak water from the through hole.

Here, in wrapping the laminated body around the ceramic base 17g, the laminated body is wrapped such that both ends along the front-rear direction L of the laminated body are spaced from each other. Thus, at a wrap-meeting part on the outer surface of the ceramic heater 171, a slit 17v forming a recessed groove along the front-rear direction L is formed as a non-heat generation portion.

Next, with reference to FIG. 3 again, features of the liquid heating device 200 according to the first embodiment will be described.

As shown in FIG. 3, the fixation member 180 fills the outer side of the front-end lid 107, thereby sealing the gaps between the openings 107m1 to 107m3 and the ceramic heaters 171 to 173 in a liquid-tight state and fixing the ceramic heaters 171 to 173 to the container 100 (openings 107m1 to 107m3).

Further, the front-end lid 107 including the inlet 103 is buried in the fixation member 180, so that a part of the inlet 103 and further a part of the flow path 103i (trunk portion 101 side) penetrate from outside through inside of the fixation member 180, so as to form a penetration portion 180p.

Thus, the liquid W before heated passes through the flow path 103i at the penetration portion 180p, whereby the fixation member 180 is cooled. Therefore, when such a structure that heats the liquid by only the outer surface of the ceramic heater without passing the liquid through the inner hole is adopted, even if the heating temperature of the heater becomes high, overheating of the fixation member 180 around the ceramic heaters 171 to 173 is suppressed, and therefore thermal deformation of the container 100 (front-end lid 107) contacting with the fixation member 180 can be suppressed and liquid leakage between the ceramic heater and the container can be suppressed.

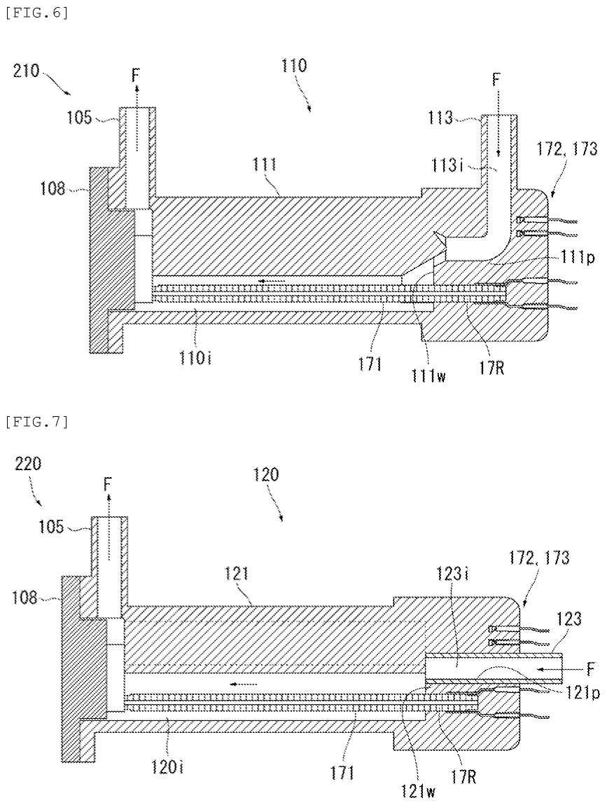

Next, with reference to FIG. 6, a liquid heating device 210 according to the second embodiment of the present invention will be described. FIG. 6 is a sectional view as seen in the same direction as FIG. 3. Of the liquid heating device 210, the same constituent parts as those of the liquid heating device 200 are denoted by the same reference characters, and the description thereof is omitted.

The liquid heating device 200 includes a container 110 and three ceramic heaters 171 to 173. The container 110 includes a trunk portion 111, a rear-end lid 108 that closes an opening at one end in the axial direction of the trunk portion 111, and an inlet 113 and an outlet 105 for a liquid W.

Here, the trunk portion 111 has a triangular tubular shape (a tubular shape whose cross-section is a triangle) which is substantially the same as the shape of the trunk portion 101, but is different from the trunk portion 101 in that the front-end lid 107 is not provided and the base-end portions 17T of the ceramic heaters 171 to 173 are buried in a wall 111w on the other end side in the axial direction of the trunk portion 111. The inlet 113 is formed integrally with the trunk portion 111.

The trunk portion 111 can be produced by insert molding in which the surrounding area of the ceramic heaters 171 to 173 is filled with a resin material, for example.

Thus, the wall 111w and the ceramic heaters 171 to 173 come into close contact with each other in a liquid-tight state without gaps therebetween.

The wall 111w forms a side wall surrounding the internal space 110i of the container 110. The wall 111w is formed so as to bury not only the base-end portions 17R of the ceramic heaters 171 to 173 but also parts of the lead terminals 18 and the lead wires 15, 16.

The shape of the inlet 113 is substantially the same as the shape of the inlet 103 of the first embodiment. Specifically, the inlet 113 protrudes upward of the wall 111w so as to cross the upper side of the wall 111w having substantially a triangular shape as seen in the axial direction, and the protruding end is a flow-in side.

The inlet 113 extends vertically from the protruding end to the vicinity of the center of the wall 111w (center surrounded by three ceramic heaters 171 to 173), and then is bent to extend along the axial direction and opens at the inner surface of the wall 111w, thus facing the internal space 110i.

In this way, a part (trunk portion 111 side) of a flow path 103i of the inlet 113 penetrates from outside through inside of the wall 111w, so as to form a penetration portion 111p.

Thus, the liquid W before heated passes through the flow path 113i at the penetration portion 111p, whereby the wall 111w is cooled. Therefore, when such a structure that heats the liquid by only the outer surface of the ceramic heater without passing the liquid through the inner hole is adopted, even if the heating temperature of the heater becomes high, thermal deformation of the wall 111w around the ceramic heaters 171 to 173 can be suppressed and liquid leakage between the ceramic heater and the container can be suppressed.

In the example in FIG. 6, the trunk portion 111 is insert-molded around the ceramic heaters 171 to 173, so that the wall 111w and the ceramic heaters 171 to 173 are brought into close contact with each other (sealed) in a liquid-tight state without gaps therebetween, but the present invention is not limited thereto.

For example, as in FIG. 3, openings for the ceramic heaters 171 to 173 to penetrate may be provided in the wall 111w, and the gaps between the ceramic heaters 171 to 173 and the openings may be sealed and fixed in a liquid-tight state by epoxy resin.

In the present invention, the outer diameter of the ceramic heater may be not greater than 5 mm. In this case, even if the ceramic heater has an inner hole, the diameter of the inner hole is small so that it is difficult to introduce the liquid and the ceramic heater is likely to be overheated. Therefore, the present invention works more effectively.

As shown in FIG. 2, FIG. 3, and FIG. 6, in the present invention, a plurality of ceramic heaters 171 to 173 extending in the front-rear direction L may be provided apart from each other, and the flow path 103i may be formed between at least two ceramic heaters 172, 173 as seen in the front-rear direction L.

Thus, it is possible to effectively cool a part where heat is likely to be accumulated between the two ceramic heaters 172, 173 across the flow path 103i.

In the present invention, an axis-n direction of an end part facing the internal space 100i, of the flow path 103i, may be along the front-rear direction L.

Thus, the liquid W readily flows on the outer surfaces of the ceramic heaters 171 to 173 along the front-rear direction L in which the ceramic heaters 171 to 173 extend, whereby a state in which the cooling effect is reduced due to the liquid W staying near the flow path 103i can be suppressed.

It should be understood that the present invention is not limited to the above embodiments and incorporates various modifications and equivalents within the idea and the scope of the present invention.

For example, the shapes of the liquid heating device, the ceramic heater, the inlet, and the flow path are not limited.

The fixation member may be made of epoxy resin or glass, for example.

The entire container may be composed of one member formed by integral molding or the like.

In addition, for example, in FIG. 3, the base-end sides of all of the plurality of (three) ceramic heaters 171 to 173 are placed at one end (front-end lid 107 side) of the container 100. However, the base-end side of at least one ceramic heater may be placed at each of both ends (front-end lid 107 side and rear-end lid 108 side) of the container 100.

In this case, the position of the outlet for the liquid W is around the center in the axial direction of the container 100.

In a case of a structure in which the trunk portion 111 is insert-molded around the ceramic heaters 171 to 173 as shown in FIG. 6, if the direction (front-rear direction) L in which the ceramic heaters 171 to 173 extend and the direction in which the inlet 113 extends are different from each other (in FIG. 6, perpendicular to each other), it is difficult to extract a molded product from an insert mold. In this case, it might be necessary to use a more complicated slide mold or it might be difficult to perform molding.

Accordingly, as in a liquid heating device 220 shown in FIG. 7, such a structure that the direction in which an inlet 123 extends is aligned with the direction (front-rear direction) L in which the ceramic heaters 171 to 173 extend, is preferable in terms of production.

In the example in FIG. 7, specifically, a trunk portion 121 of a container 120 has a triangular tubular shape (a tubular shape whose cross-section is a triangle) which is substantially the same as the shape of the trunk portion 111, and the base-end portions 17T of the ceramic heaters 171 to 173 are buried in a wall 121w on one end side in the axial direction of the trunk portion 121, as in the trunk portion 111, but the inlet 123 is not formed integrally with the trunk portion 121.

Internal spaces 120i are formed separately around the three ceramic heaters 171 to 173 individually, and the wall 121w has an opening extending in the front-rear direction L so as to communicate with inside of each internal space 120i.

The tubular inlet 123 is fitted to the above opening and the gap therebetween is sealed in a liquid-tight state by epoxy resin.

Therefore, also in the example in FIG. 7, a part (side fitted to the trunk portion 111) of the flow path 123i of the inlet 123 penetrates from outside through inside of the wall 121w, so as to form a penetration portion 121p.

Thus, the liquid W before heated passes through the flow path 123i at the penetration portion 121p, whereby the wall 121w can be cooled.

In the example in FIG. 7, the cross-section of the opening to which the inlet 123 is fitted has a hexagonal shape, and the cross-section of each internal space 120i has such an elliptic shape as to come close to the center (axis) of the trunk portion 121. Thus, an outer-side part of the opening easily overlaps the inner-side part of each internal space 120i. Then, the overlapped parts communicate with each other so that the liquid W flows from the inlet 123 to each internal space 120i.

The inlet 123 has a hexagonal tubular shape. In the example in FIG. 7, the trunk portion 121 and the inlet 123 are formed as separate parts, but they may be formed integrally.

### Example

Alumina powder and glass-component powder serving as a sintering aid were crushed and mixed with water by a mill, and then were mixed with a binder, to obtain a clay-like mixture. Using an extruder, the clay-like mixture was extruded from a die with a core placed therein, to produce a tubular ceramic base, which was then cut into a predetermined length and calcined.

Meanwhile, on an alumina green sheet, using a tungsten/molybdenum paste, a heat generation body pattern was formed and further a terminal portion connected to this pattern and leading to a sheet opposite surface was printed and formed.

The printed ceramic green sheet was wrapped around the calcined ceramic base, and these were sintered integrally. An exposed terminal portion of the sintered ceramic heater was plated with Ni, and a lead member made of Ni was brazed and joined thereto by Ag solder, thus obtaining a lead-equipped ceramic heater.

Further, such ceramic heaters were inserted from the distal-end sides into the openings of the front-end lid 107 (FIG. 2) of the container made of resin, and an epoxy adhesive was provided to fill an area over the front-end lid 107 including the gaps between the heaters and the openings, thus making airtight sealing.

The entire length of each ceramic heater was set at 60 mm, the heat generation portion length was set at 30 mm, the outer diameter was set at 2.8 mm, and the room-temperature resistance value was set at 9Ω. Thus, the liquid heating devices shown in FIG. 1 to FIG. 3 were produced.

While water having a temperature of 5° C. flowed at a flow rate of 450 cc/min through the inlet of each obtained liquid heating device, application voltage per heater was controlled so that the temperature of warm water flowing out from the outlet became 35° C., and a cycle in which heater voltage application was performed for 15 seconds and the application was stopped for 15 seconds, was repeated 10 times, thus conducting a consecutive water passing test.

As a result, during the consecutive water passing test, warm water was produced without any problem, and after the test, there was no thermal deformation of the front-end lid 107 around the epoxy adhesive which was a fixation part, and water leakage did not occur.

Generally, the heat-resistant temperature of the epoxy adhesive which is a fixation part is higher than the heat-resistant temperature of resin of the container (front-end lid 107). Therefore, even if the epoxy adhesive is heated by heat from the heater, the epoxy adhesive is not significantly thermally deformed, but the front-end lid 107 is thermally deformed by heat transferred from the epoxy adhesive to the front-end lid 107 side.

### DESCRIPTION OF REFERENCE NUMERALS

17a heat generation portion
17T front-end portion of ceramic heater
17R base-end portion of ceramic heater
100, 110, 120 container
100i, 110i, 120i internal space
103i, 113i, 123i flow path
107m1-107m3 opening of the container
111w, 121w wall
171-173 ceramic heater
180 fixation member
200, 210, 220 liquid heating device
L front-rear direction
W liquid
n an axis direction of an end part facing the internal space of the flow path

1. A liquid heating device comprising:
a container surrounding an internal space and having an opening;
a ceramic heater extending in a front-rear direction and penetrating through the opening, such that a distal-end portion of the ceramic heater is located in the internal space and a base-end portion thereof is located outside the internal space, the ceramic heater having a heat generation portion at the distal-end portion; and
a fixation member sealing a gap between the opening and the ceramic heater, and fixing the ceramic heater to the container, wherein
a liquid in the internal space is heated by the ceramic heater, and
the liquid passes through a flow path penetrating from outside through inside of the fixation member, so as to be introduced into the internal space.

2. A liquid heating device comprising:
a container having a wall surrounding an internal space; and
a ceramic heater extending in a front-rear direction and penetrating the wall, such that a distal-end portion of the ceramic heater is located in the internal space and a base-end portion thereof is located outside the internal space, the ceramic heater having a heat generation portion at the distal-end portion, wherein
a liquid in the internal space is heated by the ceramic heater,
the ceramic heater is fixed to the wall, and
the liquid passes through a flow path penetrating from outside through inside of the wall at a position different from the ceramic heater, so as to be introduced into the internal space.

3. The liquid heating device according to claim 2, wherein
the wall and the ceramic heater are in close contact with each other without a gap therebetween.

4. The liquid heating device according to claim 1, wherein
an outer diameter of the ceramic heater is not greater than 5 mm.

5. The liquid heating device according to claim 1, comprising a plurality of the ceramic heaters extending in the front-rear direction apart from each other, wherein
the flow path is formed between at least two of the ceramic heaters as seen in the front-rear direction.

6. The liquid heating device according to claim 5, wherein
an axial direction of an end part facing the internal space, of the flow path, is along the front-rear direction.
